(19) United States
(12) Patent Application Publication
(10) Pub. No.: US 2015/0108856 A1
(43) Pub. Date: Apr. 23, 2015

(54) ROTATING ELECTRIC MACHINE

(71) Applicant: NIPPON PISTON RING CO., LTD, Saitama-shi (JP)

(72) Inventors: Masafumi SAKAMOTO, Saitama-shi (JP); Shigeyoshi SATO, Saitama-shi (JP); Shunsuke TAKEGUCHI, Saitama-shi (JP)

(73) Assignee: NIPPON PISTON RING CO., LTD, Saitama-shi (JP)

(21) Appl. No.: 14/518,737

(22) Filed: Oct. 20, 2014

(30) Foreign Application Priority Data
Oct. 23, 2013 (JP) 2013-220285

(51) Int. Cl. H02K 7/10; H02K 3/52

(52) U.S. Cl. CPC H02K 7/1008; H02K 3/521
USPC 310/48; 310/75 R; 310/80

(57) ABSTRACT

In order to achieve improvement in speed and torque of a rotating electric machine according to an inexpensive, simple, and highly reliable method, Provided is a rotating electric machine including: a stator; a rotor that is rotatably arranged with an intermediation of an air gap in a rotating shaft direction with respect to the stator; and a primary-side mechanism that rotates concentrically with a shaft center of the rotor. The primary-side mechanism includes: a fixed position rotating pulley that is arranged so as to be immovable in the rotating shaft direction; and a variable position rotating pulley that is arranged so as to be movable in the rotating shaft direction with respect to the fixed position rotating pulley. The variable position rotating pulley rotates and moves in an axial direction integrally with the rotor.

### BACKGROUND OF THE INVENTION

1. Field of the Invention

The present invention relates to a rotating electric machine, and, more particularly, to an axial gap type rotating electric machine that is used as an electric motor and a power generator and includes a variable air gap, as well as the axial gap type rotating electric machine combined with a transmission.

2. Description of the Related Art

Reduction in weight, thickness, length, and size of rotating electric machines which are electric motors and power generators is strongly required in the market. In recent years, improvement in energy saving and high efficiency of rotating electric machines is also increasingly required in order to address global warming. Reduction in vibration, noise, and cost of rotating electric machines is also strongly required. Under the circumstances, an axial gap type rotating electric machine having an air gap in a rotating shaft direction has a flattened shape, which is advantageous for reduction in thickness. Further, if a rotor of the axial gap type rotating electric machine is formed in a discoid shape, inertia thereof can be reduced, and hence the axial gap type rotating electric machine is suitable for a constant speed operation and a variable speed operation. Consequently, the axial gap type rotating electric machine starts to attract attention in recent years.

Japanese Patent Laid-Open No. 2012-130086 is proposed as a related conventional art.

Rotating electric machines are categorized into a radial gap type and an axial gap type, and rotation principles of the two types are the same as each other.

A brushless DC motor (hereinafter, abbreviated as BLDCM) and a synchronous power generator, in which a permanent magnet is used for a rotor, or a switched reluctance motor (hereinafter, abbreviated as SRM), in which a permanent magnet is not used for a rotor and teeth of a magnetic material are provided instead, are used as conventional general radial gap type rotating electric machines. According to an art for the BLDCM and the synchronous power generator or the SRM, a stator iron core is formed by laminating silicon steel plates, and, in a case of placing importance on an inexpensive price and efficiency, a winding wire is generally wound in a concentrated manner.

If a winding wire is wound in a distributed manner, a coil end portion that does not contribute to torque generation becomes large, a copper loss increases, and efficiency decreases. In comparison, if a winding wire is wound in a concentrated manner, the winding wire is simple and can be wound directly in a slot, so that the winding wire can be inexpensive.

In recent years, axial gap type BLDCM and SRM are also studied as in-vehicle motors for driving hybrid cars and electric cars. This is because flattened shapes of these motors are convenient in a case where these motors are provided together with an engine or are configured as in-wheel motors. It is known that, particularly for the axial gap type BLDC motor, field strengthening control is performed at the time of start-up and low-speed rotation in order to obtain a high torque, whereas field weakening control is performed at the time of high-speed rotation in order to obtain high-speed rotation. A reason for performing such field control is as follows: at the time of a low speed, if a field system magnetic flux is large, a high torque is obtained; but, at the time of a high speed, if the field system magnetic flux is large, an electromotive force constant is also large, a motor internal induced voltage approaches a power supply voltage, and this prevents current from flowing and makes the torque lower. In order to avoid this, it is conceivable to perform field control using a multipolar permanent magnet field motor, but such control using the multipolar permanent magnet field motor is complicated and expensive because, for example, a vector control technique needs to be effectively utilized. In this regard, in a case of the axial gap type BLDCM and SRM, if the rotor is moved in an axial direction such that a distance that is an air gap between a stator and a rotor becomes shorter at the time of low-speed rotation and becomes longer at the time of high-speed rotation, characteristics similar to those obtained by control for strengthening or weakening the field system magnetic flux can be produced.

In a case where an axial gap type motor is used as a power source of an electric vehicle (hereinafter, abbreviated as EV), if only field control is performed, a high load torque is necessary at the time of start-up. In a case of direct driving, a motor size is larger, which is problematic in terms of both economies and a weight. Hence, it is necessary to drive a load using a speed reducer. In particular, a continuously variable transmission (hereinafter, abbreviated as CVT) in which a V-shaped belt and a tapered pulley are combined with each other is widely used as the speed reducer.

FIG. 14 is a cross sectional view illustrating an axial gap type BLDCM according to a typical conventional technique to which a continuously variable transmission (so-called CVT) is attached. In a general example, a stator iron core 19 is formed by laminating silicon steel plates, the number of portions of the stator iron core 19 is six, a winding wire 2 has three phases, and a rotor is tetrapolar. Illustration of a Hall element and the like is omitted. The rotor includes a permanent magnet 18. The permanent magnet 18 includes four fan-shaped segment magnets magnetized in an axial direction. Opposite polarities of the segment magnets are alternately arranged in a circumferential direction. The permanent magnet 18 is arranged so as to be planarly opposed to the stator iron core 19 with the intermediation of an air gap in the axial direction. That is, the conventional axial gap type BLDCM illustrated in FIG. 14 is of plane air gap type. The rotor includes a back yoke 17. The back yoke 17 forms a magnetic circuit. The rotor includes a rotating shaft 7. The rotating shaft 7 has a tapered surface at its leading end, is immovable in a thrust direction, and is rotatably held by the stator iron core 19 with the intermediation of a bearing 11. In this way, the back yoke 17 and the permanent magnet 18 are integrally configured to form the rotor. A driving unit, that is, a motor is configured as described above.

The rotor further includes a pulley 8. The pulley 8 is arranged so as to be movable in the thrust direction and be rotatable together with the rotating shaft 7, and has a tapered surface (so-called inclined surface) formed correspondingly to the tapered surface of the rotating shaft 7. The mutually opposing tapered surfaces of the rotating shaft 7 and the pulley 8 define a V-shaped groove, and a V-shaped belt 15 is sandwiched and held by the tapered surfaces in the groove. Normally, the pulley 8 is controlled so as to pressurize the V-shaped belt 15 by means of a hydraulic pressure, a spring pressure, or the like (not illustrated). A driving side is configured as described above. These are referred to as primary side, for ease of description. If a three-phase alternating current is caused to flow in the winding wire 2, a rotating magnetic field is generated in the motor, and the V-shaped belt 15 is driven. The V-shaped belt 15 drives a load shaft 20. The load shaft 20 has a shape similar to that of the rotating shaft 7, and thus has a tapered surface at its leading end. A pulley 21 rotatably provided to the load shaft 20 has a shape similar to that of the pulley 8, is arranged so as to be movable in the thrust direction and be rotatable together with the load shaft 20, and has a tapered surface formed correspondingly to the tapered surface of the load shaft 20. Similarly to the primary side, the V-shaped belt 15 is sandwiched and held by the tapered surfaces of the load shaft 20 and the pulley 21. The pulley 21 always pressurizes the V-shaped belt 15 by means of a spring 23 with a stopper 22 fixedly attached to the load shaft 20 serving as a point of force application. A load is connected to a right end of the load shaft 20. These are referred to as secondary side, for ease of description. For example, in a case of an EV, the primary side corresponds to a motor, and the secondary side corresponds to a drive axle tire. A continuously variable transmission is configured as described above. That is, if the motor is started up, a tension of the V-shaped belt 15 increases. Hence, the pulley 8 moves rightward in FIG. 14, so that a diameter of the V-shaped belt 15 on the primary side becomes smaller. Conversely, on the secondary side, the V-shaped belt 15 becomes looser, and hence the pulley 21 enters an inner periphery of the V-shaped belt 15 due to the pressurization of the spring 23, so that the belt diameter becomes larger. That is, a speed reducer is formed, and a high load torque can be driven. This state is opposite to a state illustrated in FIG. 14. Conversely, at the time of high-speed rotation, because the load torque is reduced, the tension of the V-shaped belt 15 becomes looser on the driving side, or the pulley 8 enters the inner periphery of the V-shaped belt 15 due to the control that is performed on the pulley 8 by means of the hydraulic pressure, the spring pressure, or the like. As a result, the diameter of the V-shaped belt 15 becomes larger on the driving side, and becomes smaller on the load side, whereby a speed increaser is formed. This state is equal to the state illustrated in FIG. 14. In this way, a continuously variable speed is achieved.

Unfortunately, in a case where speed control is necessary for a wide range from a low speed to a high speed as in use for particularly an EV and the like, the speed control cannot be satisfactorily efficiently performed using only the CVT. Hence, field weakening control is necessary at the time of a high speed, and field strengthening control is necessary at the time of a low speed. In order to perform the field weakening control and the field strengthening control, extra electric power or complicated vector control for the field control is necessary. It is known that, if an air gap length between a rotor and a stator is made variable in an axial gap type motor, effects equivalent to those obtained by performing the field weakening control at the time of a high speed and the field strengthening control at the time of a low speed can be relatively easily produced.

Japanese Patent Laid-Open No. 2012-130086 is known as a conventional art for further forcibly varying a gap length in the typical axial gap type BLDC motor by means of an external force. Unfortunately, a method according to the conventional art has the following disadvantages. That is, in case of plane air gap type in which a field magnet and a stator iron core are planarly opposed to each other, compared with radial gap type motors, a torque is small for the reason that a minimum air gap cannot be made small and other reasons, and practicality is not sufficient in actual use. That is, compared with the radial gap type, an air gap length in the axial gap type needs to be approximately twice larger in consideration of rotor plane deflection, so that a torque decreases accordingly. Furthermore, air gap length-to-torque characteristics do not linearly change but non-linearly change, and hence controllability is not favorable.

The present invention, which has been made in view of the above-mentioned problems, adopts a three-dimensional air gap type motor having a motor structure suitable for a CVT, and thus provides an axial variable gap type motor that is compact and includes the CVT, in which a variable air gap rotor and a variable position rotating pulley of the CVT are combined with each other for integration of the motor and the CVT. The present invention, which has been made in order to solve the above-mentioned problems, provides an inexpensive high-performance axial motor.

### SUMMARY OF THE INVENTION

A rotating electric machine according to the present invention includes: a stator; a rotor that is rotatably arranged with an intermediation of an air gap in a rotating shaft direction with respect to the stator; and a primary-side mechanism that rotates concentrically with a shaft center of the rotor. The primary-side mechanism includes: a fixed position rotating pulley that is arranged so as to be immovable in the rotating shaft direction; and a variable position rotating pulley that is arranged so as to be movable in the rotating shaft direction with respect to the fixed position rotating pulley. The variable position rotating pulley rotates and moves in an axial direction integrally with the rotor.

In the rotating electric machine according to the present invention, the variable position rotating pulley may include a conical internal space part between the variable position rotating pulley and the rotor, a plate having a surface oppositely inclined to an inner wall surface of the conical internal space part may be provided in the space part so as to be immovable in the axial direction, a weight made of one piece or a plurality of divided pieces may be arranged in a circumferential direction of the rotating shaft in a space defined by the inner wall surface of the conical internal space part and the plate, and the pieces of the weight may be connected continuously using an elastic member that urges the weight in a diameter reducing direction as needed.

In the rotating electric machine according to the present invention, the rotor may include a permanent magnet that has an even number of poles and is magnetized into opposite polarities in the circumferential direction.

In the rotating electric machine according to the present invention, the rotor may not include a permanent magnet.

In the rotating electric machine according to the present invention, the stator may include a stator iron core part including a plurality of salient-pole iron cores for a winding wire, the salient-pole iron cores for the winding wire may include first tooth parts that protrude in the axial direction and are formed in a concentric arc-like manner, a plurality of the salient-pole iron cores for the winding wire may each have a winding wire shaft formed parallel to the rotating shaft and may be arranged in a distributed manner in the circumferential direction, the rotor may include rotor magnetic poles that are made of a plurality of magnetic materials and are arranged in a distributed manner in the circumferential direction, and each of the rotor magnetic poles may include second tooth parts that protrude in the axial direction and are formed in a concentric arc-like manner, the second tooth parts being opposedly arranged so as to respectively engage with the first tooth parts with the intermediation of the air gap.

In the rotating electric machine according to the present invention, a continuously variable transmission may be configured by: forming a variable width V-groove using the fixed position rotating pulley and the variable position rotating pulley of the primary-side mechanism and a fixed position rotating pulley and a variable position rotating pulley of the primary-side mechanism and a secondary-side mechanism; and stretching a V-shaped belt around the variable width V-groove.

In the rotating electric machine according to the present invention, electric power may be inputted to any one of the stator and the rotor, the one including a winding wire, the primary-side mechanism may be rotated, and an output may be obtained from the secondary-side mechanism.

In the rotating electric machine according to the present invention, a driving force generated by an external force such as wind power, water power, or an engine may be inputted to the secondary-side mechanism, and a rotating electric machine provided to the primary-side mechanism may be used as a power generator.

If a device that moves the rotor of the axial variable gap type rotating electric machine according to the present invention in the axial direction is directly connected to a variable position rotating pulley of a CVT, the rotor and the variable position rotating pulley move in an integrated manner, and characteristics of a high torque at the time of a low speed and high-speed rotation and a high output at the time of a high speed produce synergistic effects of the motor and the CVT.

The axial gap type BLDCM according to the present invention can rotate in a state where the first tooth parts formed in the stator and the second tooth parts formed in the rotor engage with each other. Hence, an interlinkage magnetic flux of the motor of the present invention can be more than twice as large as that of a plane gap type motor, and torques thereof at the time of start-up and a low speed can also be more than twice. Moreover, in the motor of the present invention, a concavo-convex engagement portion also includes a radial gap. Hence, the motor of the present invention generates lower noise compared with a conventional axial gap type motor. The first tooth parts formed in the stator and the second tooth parts formed in the rotor opposedly engage with each other in an air gap opposing portion therebetween, and hence an opposing area increases, whereby a high-efficiency rotating electric machine having a high air gap permeance is obtained. With regard to an increase in air gap, because the attraction force in the axial direction and the torque of the rotating electric machine are substantially proportional to the air gap length, the torque can be easily controlled by controlling the air gap length.

An axial gap type SRM according to the present invention can rotate in a state where the first tooth parts that are formed in the stator in concavo-convex shapes and the second tooth parts that are formed in the rotor engage with each other. Hence, the SRM of the present invention is also superior to conventional arts.

Further, if an axial gap type rotating electric machine according to the present invention is applied to a main driving machine of an electric car, electric power required for field strengthening at the time of a low speed and field weakening at the time of a high speed is not necessary, so that driving efficiency can be enhanced.

In the axial gap type rotating electric machine according to the present invention, if a secondary-side shaft of the CVT is driven by wind power, speed increasing control is performed at the time of a gentle wind, and speed reducing control is performed at the time of a strong wind, whereby a power generator that generates substantially constant electric power can be configured.

### BRIEF DESCRIPTION OF THE DRAWINGS

FIG. 1 is a cross sectional view in an axial direction of a rotating electric machine according to a first embodiment of the present invention;

FIG. 2 is an II-II cross sectional view in FIG. 1;

FIG. 3 is a III-III cross sectional view in FIG. 1;

FIG. 4A is a cross sectional view in an axial direction of a rotating electric machine according to a modified example of the first embodiment of the present invention;

FIG. 4B is a cross sectional view in an axial direction of a rotating electric machine according to another modified example of the first embodiment of the present invention;

FIG. 5 is a partial cross sectional view of a weight in FIG. 4A and FIG. 4B;

FIG. 6 is an operation explanatory view of a rotating electric machine according to the present invention;

FIG. 7 is an operation explanatory view of the rotating electric machine according to the present invention;

FIG. 8 is an operation explanatory view of a rotating electric machine according to a second embodiment of the present invention;

FIG. 9 is an operation explanatory view of the rotating electric machine according to the second embodiment of the present invention;

FIG. 10 is an operation explanatory view of a rotating electric machine to which a CVT is attached according to another example of the present invention;

FIG. 11 are operation explanatory views of the rotating electric machine according to the present invention;

FIG. 12 is a characteristic explanatory graph of the rotating electric machine according to the present invention;

FIG. 13 is a characteristic explanatory graph of the rotating electric machine according to the present invention; and

FIG. 14 is an operation explanatory view of a rotating electric machine according to a conventional art.

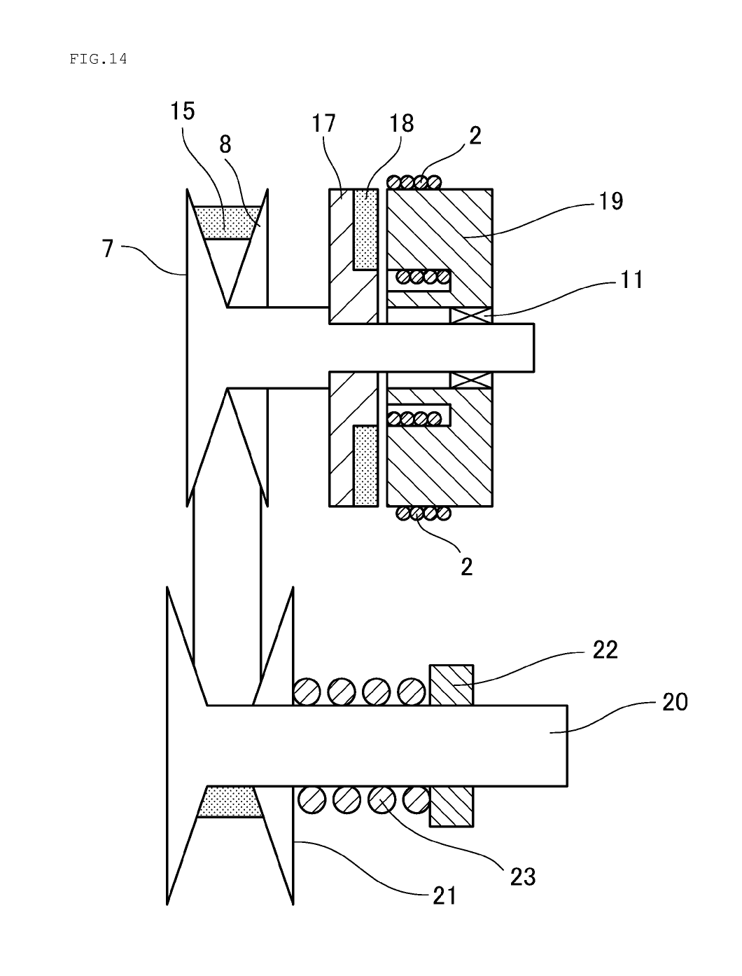

### DETAILED DESCRIPTION OF THE PREFERRED EMBODIMENTS

Hereinafter, description is given with reference to the drawings.

### EMBODIMENTS

### First Embodiment

A stator iron core part 1 and rotor magnetic poles 4 or a back yoke 6 of a permanent magnet 5 and the like of an axial gap type motor of the present invention can be easily and inexpensively manufactured by pressing soft magnetic iron powder. According to a method of laminating silicon steel plates, in a case of a conventional radial gap type, iron cores each having a two-dimensional shape are laminated in an axial direction, and a magnetic path of a field system magnetic flux is planar and perpendicular to an axis. In the axial gap type motor, a magnetic path of a field system magnetic flux is three-dimensional, and hence the method of laminating silicon steel plates has a problem that the magnetic flux has difficulty in passing in a lamination direction. This is another reason why the axial gap type motor does not become more popular than the radial gap type motor. In this regard, the pressed powder core is non-directional, and thus is suitable to configure a three-dimensional shape. The pressed powder core is obtained by coating soft magnetic iron powder with resin, pressurizing the coated powder, and then heating the pressurized powder. From the pressed powder core, an article having a complicated shape can be manufactured using a press die. Magnetic permeability of the pressed powder core is lower than that in a rolling direction of the silicon steel plates, but a magnetic flux passing direction thereof is non-directional. Because particles of the iron powder are insulated from each other by the coating resin, an eddy current does not occur, and an iron loss is small in the obtained iron core.

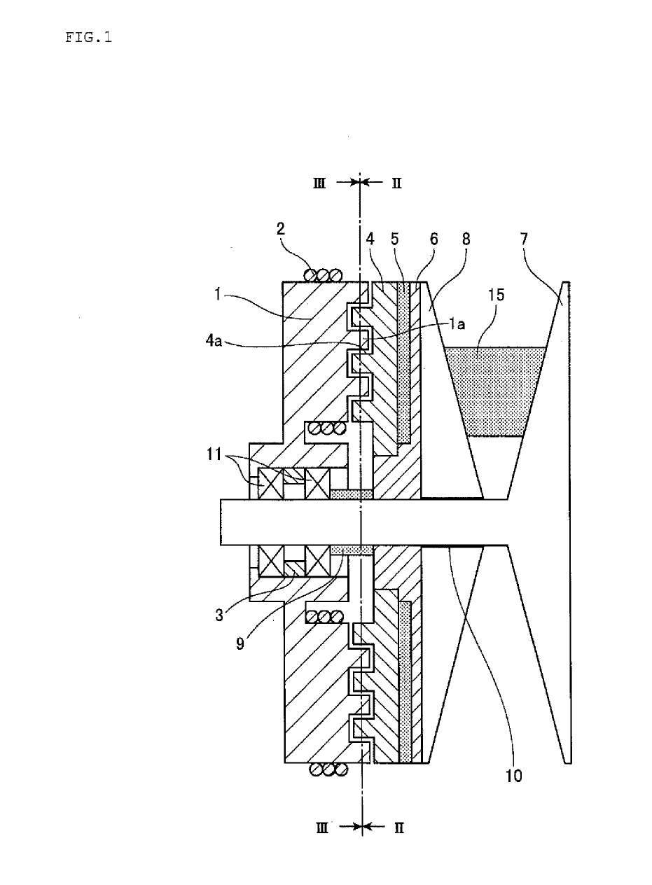

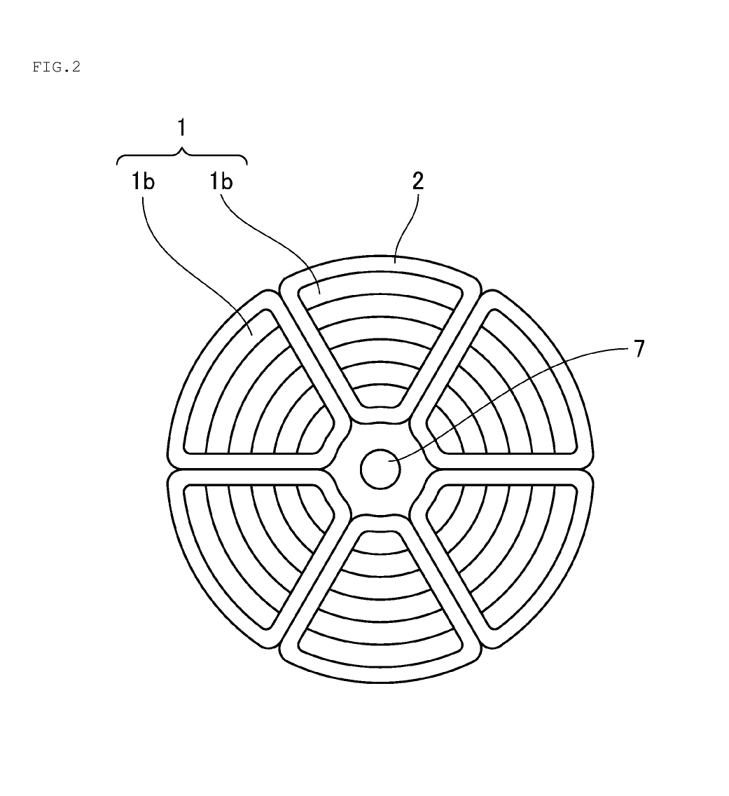

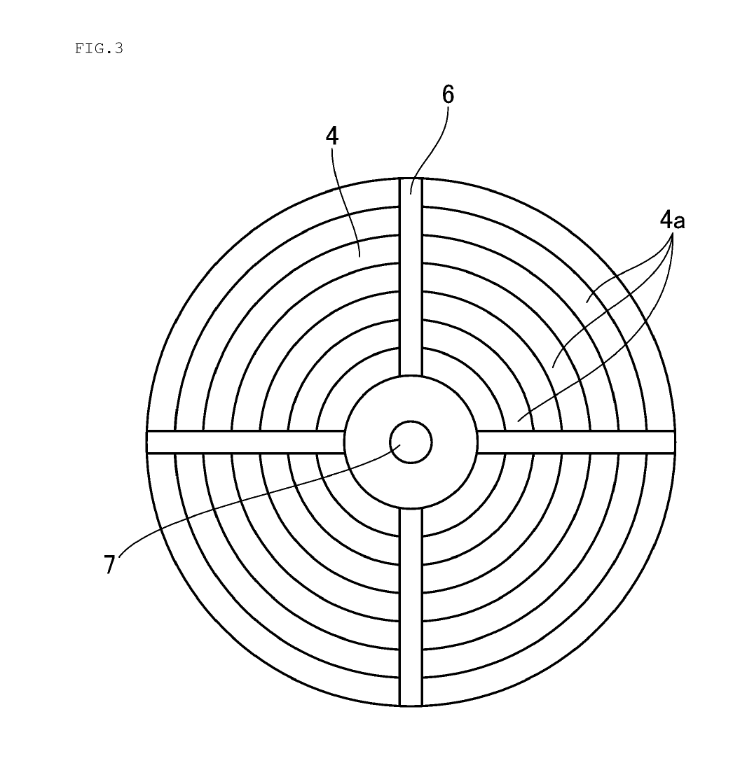

FIG. 1 illustrates a part of a configuration of the present invention, which illustrates an axial-rotation variable single gap type rotating electric machine and primary-side component of CVT. FIG. 2 is a cross sectional view indicated by arrows II-II in the rotating electric machine of FIG. 1, and FIG. 3 is a cross sectional view indicated by arrows III-III in the rotating electric machine of FIG. 1. A first embodiment of the present invention is described with reference to FIGS. 1 to 3.

As illustrated in FIG. 2, the stator iron core part 1 includes salient-pole iron cores for a winding wire 1b that are made of the pressed powder core and the like and are arranged in a discoid manner. As illustrated in FIG. 1, the salient-pole iron cores for the winding wire 1b include a plurality of first tooth parts 1a that protrude in the axial direction and are formed in a concentric arc-like manner. In an example of these drawings, the stator iron core part 1 includes six salient-pole iron cores for a winding wire 1b that are grooved and substantially fan-shaped or six divided iron cores, a winding wire 2 has three phases, and a rotor is tetrapolar. Various other combinations than this example can also be adopted. For example, the stator may have 12 slots, and the rotor may have 8, 10, or 14 poles. Alternatively, the stator may have 9 slots, and the rotor may have 8 or 10 poles.

The winding wire 2 is wound around an outer peripheral surface of the stator iron core part 1. In this case, as illustrated in FIG. 2, six winding wires are arranged in a circumferential direction, and are respectively provided in substantially fan-shapes in six groove portions of the stator iron core part 1. As illustrated in FIG. 3, the rotor includes four rotor magnetic poles 4. The magnetized permanent magnet 5 is arranged on a back surface of the rotor magnetic poles 4. The permanent magnet 5 is tetrapolar, and N poles and S poles thereof are alternately arranged.

It is desirable to: alternately magnetize four magnet pieces as the permanent magnet 5 into opposite polarities in a magnet thickness direction in the axial direction; and arrange the back yoke 6 on a back surface thereof. Alternatively, one discoid magnet as the permanent magnet 5 may be alternately magnetized into N poles and S poles, and the four rotor magnetic poles 4 may be placed on the magnetized discoid magnet in the axial direction to be fixedly attached thereto. The back yoke 6 or a rotor supporting member is arranged on the back surface of the permanent magnet 5, and is fixedly attached to a primary-side flanged rotating shaft part of a fixed position rotating pulley 7. The stator iron core part 1 and the rotor magnetic poles 4 respectively include the first tooth parts 1a and second tooth parts 4a that concentrically protrude in the axial direction, whereby the stator and the rotor engage with each other with the intermediation of a concavo-convex air gap while being rotatably opposed to each other with the intermediation of a bearing 11 and a sliding bearing 10. If the concavo-convex air gap is tried to be adopted, a radial gap type rotating electric machine cannot be assembled unless the stator iron core part 1 is divided to be combined with the rotor. In contrast, an axial gap type rotating electric machine can be easily assembled. Further, even if the stator and the rotor respectively include the first tooth parts 1a and the second tooth parts 4a for mutual concavo-convex engagement, the manufacture using the pressed powder core is easy and inexpensive. A pair of the bearings 11 is arranged, and spacers 3 and 9 are respectively provided between the pair of bearings 11 and around the rotating shaft of the fixed position rotating pulley 7. That is, in FIG. 1, the rotor magnetic poles 4, the permanent magnet 5, the back yoke 6, and the variable position rotating pulley 8 are fixedly attached to and combined with one another, to thereby form one rotor, and the rotor is rotatable and movable in the thrust direction with respect to the fixed position rotating pulley 7 including the primary-side flanged rotating shaft, with the intermediation of the sliding bearing 10. Because the fixed position rotating pulley 7 is rotatably held by the bearings 11, the fixed position rotating pulley 7 is immovable at a fixed position in the thrust direction with respect to the stator. Illustration of a Hall element and the like is omitted.

Next, an operation of FIG. 1 is described. In a case where this rotating electric machine starts up a load, a maximum current according to a started load torque and characteristics of the BLDCM flows. A larger attraction force in the axial direction is generated in the axial gap type motor than in the radial gap type motor, and the attraction force is proportional to the current. Hence, as illustrated in FIG. 1, the rotor is attracted toward the stator iron core part 1 with a predetermined minimum air gap, and starts up. Because a tension of the V-shaped belt 15 is high at the time of the start-up, the variable position rotating pulley 8 of the rotor succumbs to the tension, and the rotor starts up in a state where the rotor magnetic poles 4 are urged in a direction in which the air gap with the stator iron core part 1 becomes further smaller. That is, the rotor starts up in a state where a V-groove interval between the fixed position rotating pulley 7 and the variable position rotating pulley 8 is wider. At this time, a diameter of the V-shaped belt 15 is in a minimum state, which corresponds to a ratio for reducing a speed of a secondary-side shaft on the load side.

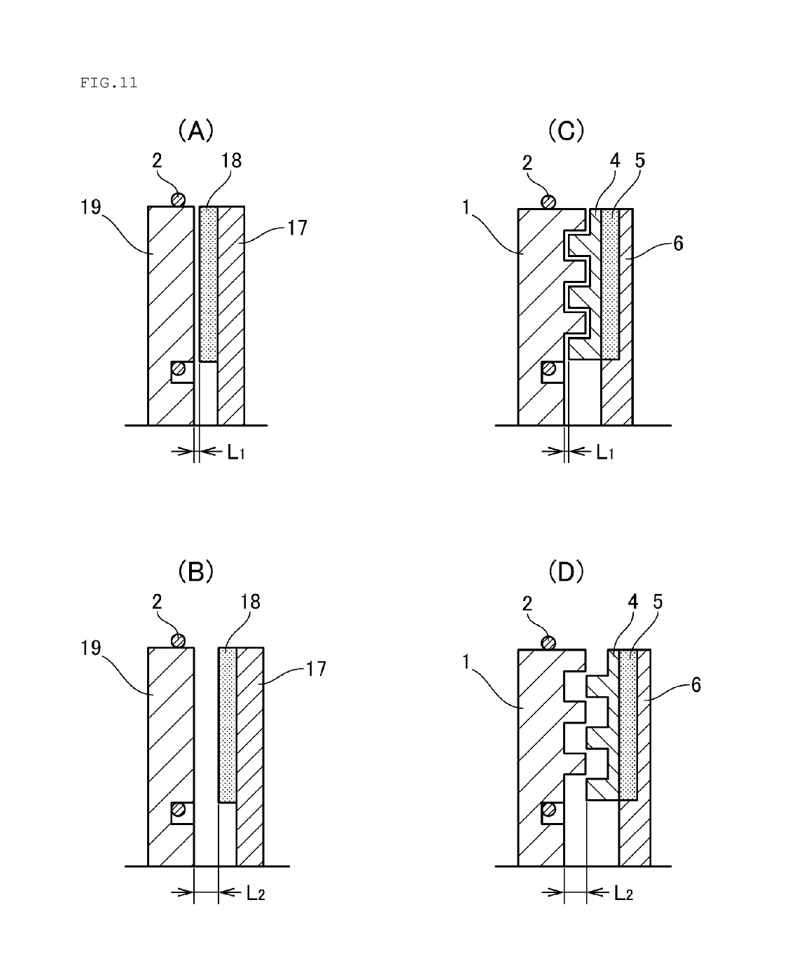

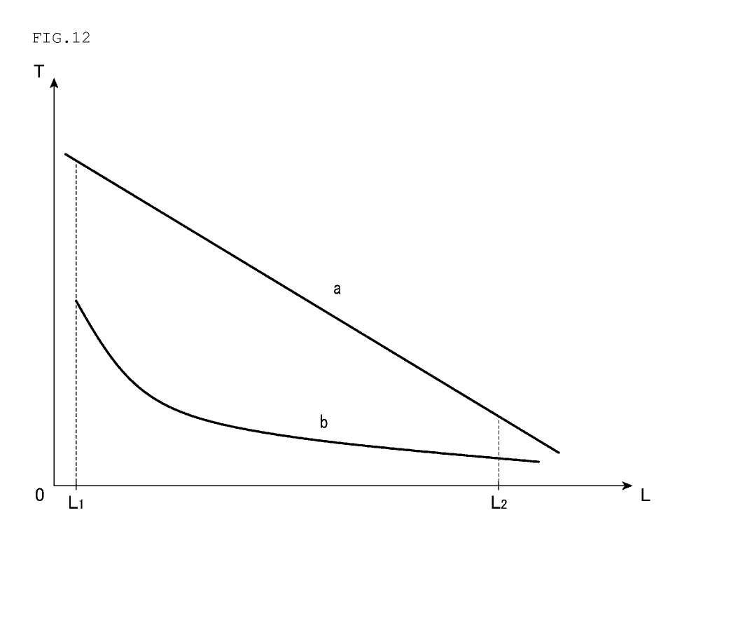

If the motor speed is increased by duty control, applied voltage control, and the like, an increase in torque due to the speed reducing ratio of the CVT is added to a high torque due to the small air gap in the rotating electric machine, whereby the resultant synergistic effect can facilitate the start-up and acceleration of the load. Then, at the time of a constant-speed operation or a high-speed operation after an end of the acceleration, the load significantly decreases compared with that at the time of the acceleration, and hence the tension of the V-shaped belt 15 also decreases. On the basis of a relation of speed-torque characteristics of the BLDCM, as the speed increases, the load current decreases, and hence the attraction force applied to the gap also decreases. At this time, if an urging device such as a coil spring pressure and a hydraulic pressure is provided in place of the spacer 9 that holds the rotating shaft of the fixed position rotating pulley 7, a tapered portion of the variable position rotating pulley 8 rotationally enters an inner periphery of the V-shaped belt 15, so that the diameter of the V-shaped belt 15 becomes larger. If the diameter of the V-shaped belt becomes larger, the air gap between the stator and the rotor becomes larger, a field weakening effect is produced, the number of rotations increases, and a speed increasing ratio is obtained on the CVT side, whereby a synergistic effect is produced. In the rotor in FIG. 1, the generated torque is transmitted to the fixed position rotating pulley 7 with the intermediation of a frictional force of the V-shaped belt 15. It is important that the gap length and the generated torque linearly change, and this can be achieved by adopting an example illustrated in FIGS. 11 and 12 to be described later.

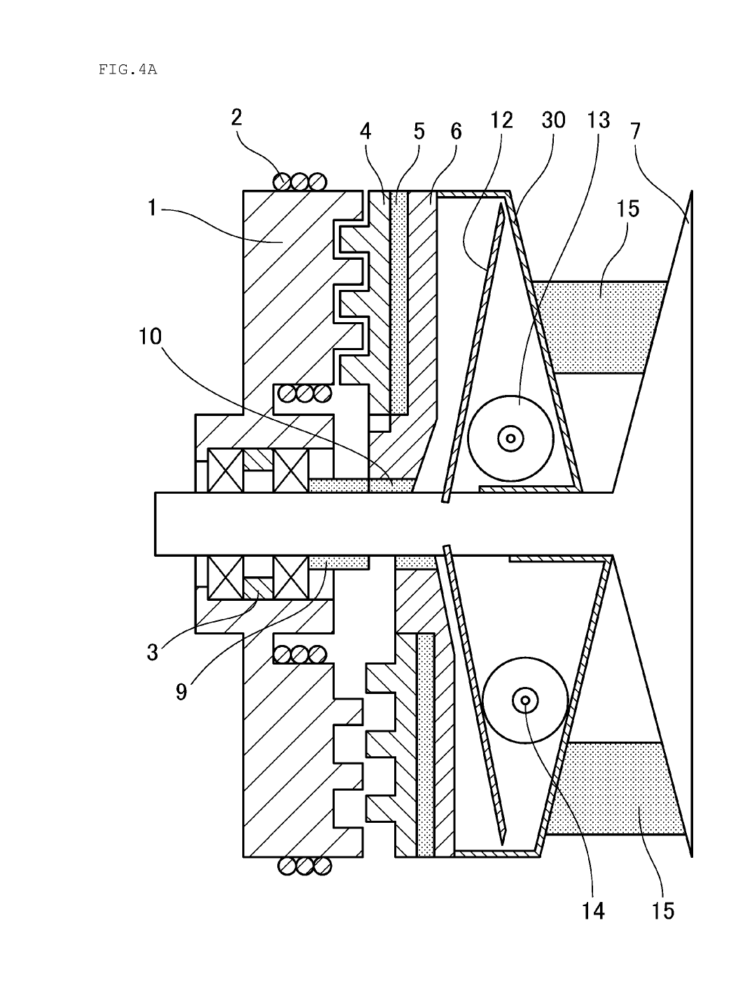

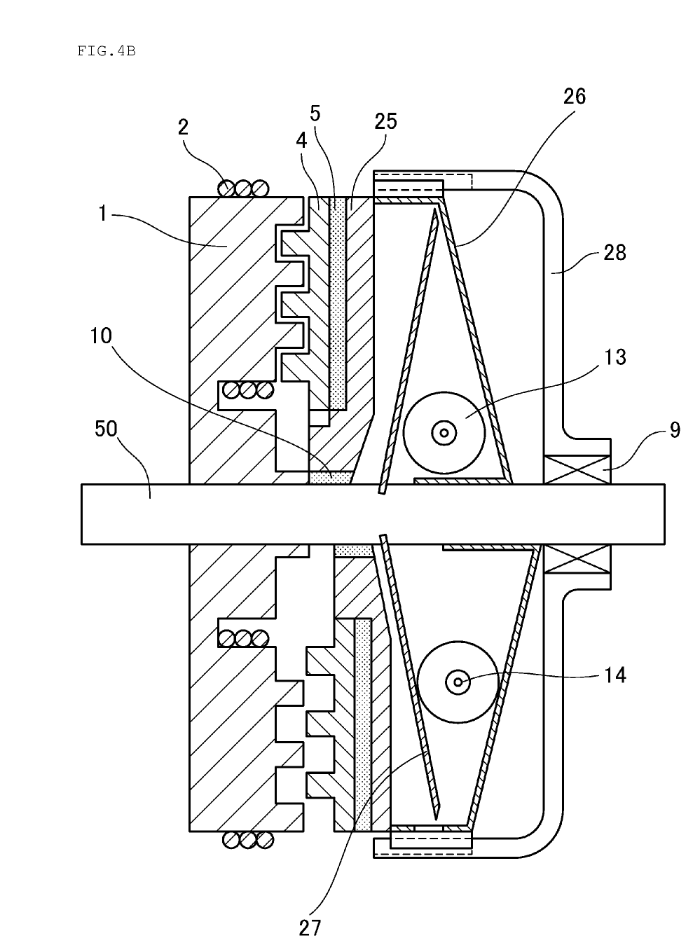

FIG. 1 illustrates an example in which the air gap in the rotating electric machine is increased and decreased by: a change in current in relation to the speed of the rotating electric machine; and the spring pressure or the hydraulic pressure. Meanwhile, FIG. 4A illustrates an example in which the air gap in the rotating electric machine is increased and decreased by using a centrifugal force. A motor unit in FIG. 4A is substantially the same as that in FIG. 1, and hence description thereof is omitted. A CVT unit in FIG. 4A is different from that in FIG. 1 in the following points. In FIG. 1, the variable position rotating pulley 8 is a solid conical member. Meanwhile, in FIG. 4A, a hollow conical member 30 provided instead is fixedly attached to an outer periphery of the back yoke (rotor supporting member) 6, and a space part is defined by the back yoke 6 and the hollow conical member 30. Further, in FIG. 4A, a plate 12 having a surface oppositely inclined to an inner wall surface of the hollow conical member 30 is provided so as to be immovable in the thrust direction. A central portion of the hollow conical member 30 is rotatable and movable in the thrust direction with the intermediation of a sliding bearing (not illustrated) with respect to the fixed position rotating pulley 7. A weight 13 made of one piece or a plurality of pieces obtained by dividing a doughnut-shaped material is arranged inside of the hollow conical member 30, that is, in a space part defined by the respective inner walls of the plate 12 and the hollow conical member 30. The weight 13 includes an elastic member 14 in its central hole portion, and the elastic member 14 urges the weight 13 in a diameter reducing direction as needed. The weight 13 is arranged around the primary-side shaft of the fixed position rotating pulley 7. Examples of the elastic member 14 include an elastic cord, an annular spring, and an elastic ring member. The V-shaped belt 15 is provided in a V-groove formed by respective inclined surfaces of the hollow conical member 30 and the fixed position rotating pulley 7. A shape of the weight 13 is not limited to the doughnut shape, and may be various appropriate shapes. For example, the weight 13 may be formed by connecting spherical weights using the elastic member 14.

An operation of FIG. 4A is described below.

In a case where this rotating electric machine starts up a load, a maximum current according to a started load torque flows on the basis of characteristics of the BLDCM. Because a larger attraction force in the axial direction is generated in the axial gap type motor than in the radial gap type motor and the attraction force is proportional to the current, as illustrated in FIG. 4A, the rotors are attracted toward the stator iron core part 1 with a predetermined minimum air gap, and start up. Because the tension of the V-shaped belt 15 is high at the time of the start-up, the hollow conical member 30 of the rotor succumbs to the tension, and the rotor starts up in a state where the rotor magnetic poles 4 are urged in a direction in which the air gap with the stator iron core part 1 becomes further smaller. That is, the rotor starts up in a state where a V-groove interval between the fixed position rotating pulley 7 and the hollow conical member 30 is wider. At this time, the diameter of the V-shaped belt 15 is in a minimum state, which corresponds to a ratio for reducing a speed of the secondary-side shaft on the load side.

If the motor speed is increased by duty control, applied voltage control, and the like, an increase in torque due to the speed reducing ratio of the CVT is added to a high torque due to the small air gap in the rotating electric machine, whereby the resultant synergistic effect can facilitate the start-up and acceleration of the load. This state corresponds to an upper half of FIG. 4A from a horizontal center line. Then, at the time of a constant-speed operation or a high-speed operation after an end of the acceleration, the load significantly decreases compared with that at the time of the acceleration, and hence the tension of the V-shaped belt 15 also decreases. On the basis of a relation of speed-torque characteristics of the BLDCM, as the speed increases, the load current decreases, and hence the attraction force applied to the gap also decreases.

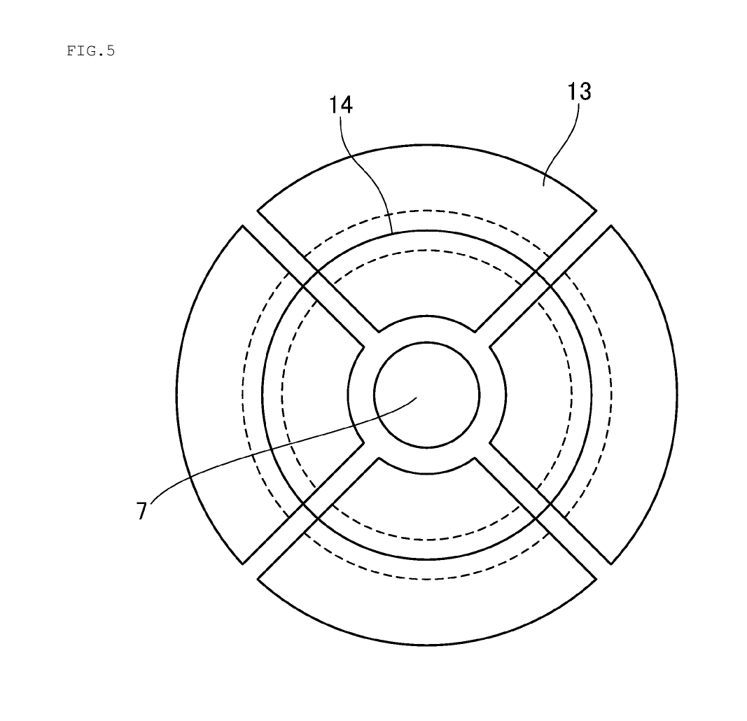

At this time, as the speed increases, a centrifugal force, which is a force acting toward a far side in a radial direction of the rotating shaft, is applied to the weight 13. This state corresponds to a lower half of FIG. 4A. That is, the weight 13 pushes the respective inner walls of the hollow conical member 30 and the plate 12 outward by means of the centrifugal force. In this state, because the plate 12 is fixed to the rotating shaft of the fixed position rotating pulley 7 so as to be immovable in the thrust direction, the hollow conical member 30 moves rightward in FIG. 4A, pushes the V-shaped belt 15 in an outer circumferential direction, and makes the diameter of the V-shaped belt 15 larger, so that the speed increasing ratio is obtained. At a same time, the rotor magnetic poles 4, the permanent magnet 5, and the back yoke 6 that form the rotor move rightward by a same amount, and increase the air gap between the stator iron core part 1 and the rotor magnetic poles 4. As a result, a field weakening effect is produced, and the motor speed is further increased. When the weight 13 is located at an outer peripheral position by means of the centrifugal force, the elastic member 14 expands. Upon a return to the speed reducing mode, because the centrifugal force is not applied to the weight 13 anymore at the time of reduction in rotation speed, the force of pushing the hollow conical member 30 rightward disappears. At a same time, a tension is applied to the V-shaped belt 15 from the load side. Hence, the hollow conical member 30 is moved leftward by the tension of the V-shaped belt 15. The rotor magnetic poles 4, the permanent magnet 5, and the back yoke 6 that form the rotor move leftward at a same time, and decrease the air gap. As a result, the elastic member 14 contracts, and the operation state returns to the upper half of FIG. 4A. FIG. 5 illustrates a state where the elastic member 14 contracts and is located around the rotating shaft of the fixed position rotating pulley 7.

FIG. 4B illustrates an example in which the air gap opens and closes by using a centrifugal force similarly to FIG. 4A. Configurations of a stator and a rotor in FIG. 4B are the same as those in FIG. 1, and hence description thereof is omitted. In the rotor, a first plate 26 is fixedly attached to an outer periphery of a back yoke 25. The first plate 26 has a hollow conical shape toward a shaft center. The first plate 26 is rotatable and movable in the axial direction with respect to a shaft 50 fixed to the stator, without contact with the shaft or with the intermediation of the sliding bearing 10, whereby the first plate 26 can move integrally with the rotor. A second plate 27 having a surface oppositely inclined to an inner wall surface of the first plate 26 is provided in a space part defined by the first plate 26 and the shaft 50 so as to be immovable in the thrust direction. The weight 13 made of one piece or a plurality of pieces obtained by dividing a doughnut-shaped material is arranged inside of the first plate 26, that is, in a space part defined by the respective inner walls of the second plate 27 and the first plate 26. The weight 13 includes the elastic member 14 in its central hole portion, and the elastic member 14 urges the weight 13 in the diameter reducing direction as needed. The weight 13 is arranged around the shaft 50. The weight 13 made of the plurality of pieces obtained by dividing the doughnut-shaped material may be made of a plurality of spherical pieces, and a shape thereof is not limited thereto. One spherical piece is possible for the weight 13, but the plurality of spherical pieces are preferable therefor because the centrifugal force evenly acts on the first plate 26 and the second plate 27. Although the first plate 26 in FIG. 4B corresponds to the hollow conical member 30 in FIG. 4A or the variable position rotating pulley 8 in FIG. 1 and has a variable gap function similar thereto, FIG. 4B is different from FIG. 4A and FIG. 1 in that an output of the electric motor is not transmitted to a secondary-side mechanism through the V-shaped belt 15 but transmitted to a rotating member 28, that is, transmitted to a primary-side mechanism. The shape of the weight 13 is not limited to the doughnut shape, and may be various appropriate shapes. For example, the weight 13 may be formed by connecting spherical weights using the elastic member 14.

An operation of FIG. 4B is described below.

In a case where this rotating electric machine starts up a load, a maximum current according to a started load torque flows on the basis of characteristics of the BLDCM and the like. A larger attraction force in the axial direction is generated in the axial gap type motor than in the radial gap type motor, and the attraction force is proportional to the current. Hence, as illustrated in an upper half of FIG. 4B from a shaft center line of the shaft 50, the rotor is attracted toward the stator iron core part 1 with a predetermined minimum air gap, and starts up.

If the motor speed is increased by duty control, applied voltage control, and the like, an internal induced voltage increases, and the current decreases, so that the attraction force in the thrust direction acting on between the stator and the rotor also decreases.

At this time, as the speed increases, a centrifugal force, which is a force acting toward a far side in a radial direction of the rotating shaft, is applied to the weight 13. This state corresponds to a lower half of FIG. 4B. That is, the weight 13 pushes the respective inner walls of the first plate 26 and the second plate 27 outward by means of the centrifugal force. In this state, because the second plate 27 is fixed to the fixed shaft 50 so as to be immovable in the axial direction, only the first plate 26 moves rightward, and the rotor moves at a same time, so that the air gap becomes larger. Upon a return to the speed reducing mode, because the centrifugal force is not applied to the weight 13 anymore at the time of reduction in the number of rotations, the force of pushing the first plate 26 rightward disappears, and the current increases at the time of low-speed rotation. Hence, the air gap is decreased up to a minimum position by a strong attraction force in the thrust direction characteristic of the axial gap type. In FIG. 4B, an external gear is formed in the rotor or an outer periphery of the first plate 26, and an internal gear that extends in the axial direction is formed in an inner periphery of the rotating member 28 that rotates at a position fixed in the axial direction. The external gear and the internal gear are configured so as to engage with each other. Even if the rotor moves in the axial direction, the two gears always engage with each other, and a rotational force can be transmitted to the rotating member 28. In a case where the motor is used to drive an in-wheel electric vehicle, a tire may be fitted to an outer periphery of the rotating member 28. Other components are the same as those in FIG. 1, and hence description thereof is omitted.

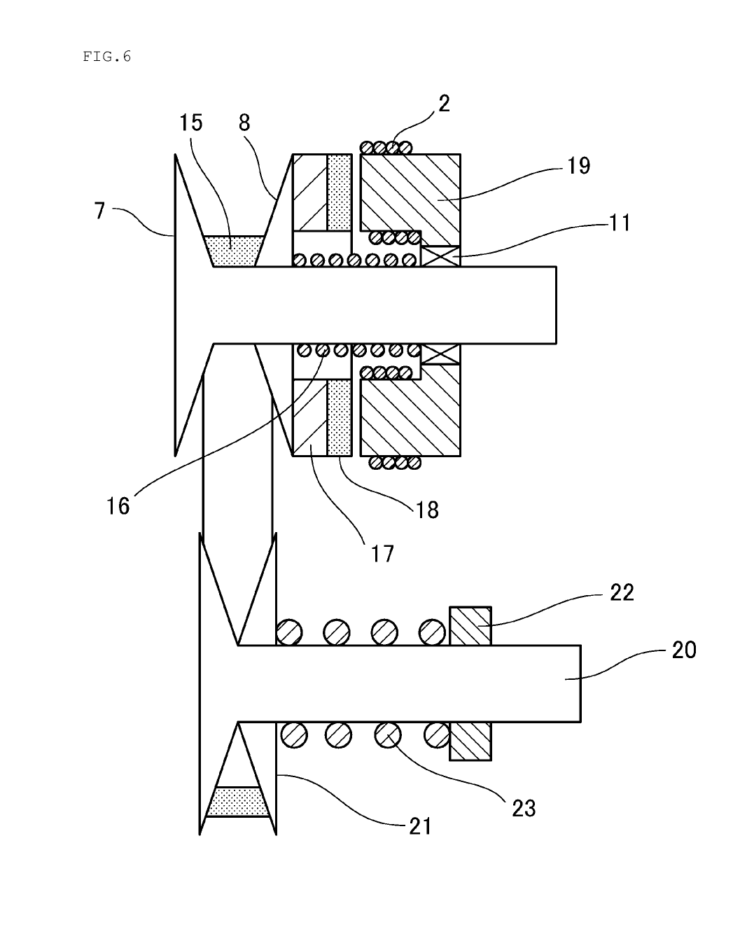

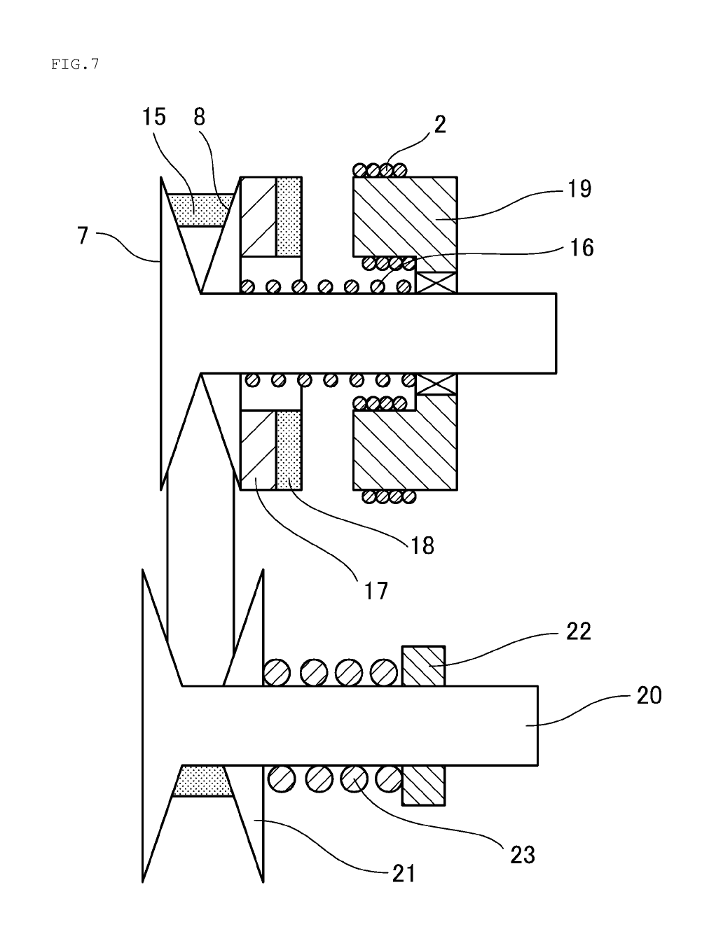

FIG. 6 and FIG. 7 are explanatory views each illustrating both a primary side and a secondary side of a CVT. Unlike FIG. 1 and FIG. 4, an air gap for mutual engagement between a stator and a rotor in a motor unit is not formed in a concavo-convex shape. Similarly to FIG. 1 and FIG. 4, FIG. 6 and FIG. 7 have an advantage that the axial gap rotor and the variable position rotating pulley 8 of the CVT are combined with each other and thus can move in the thrust direction at a same time. The rotor includes a stator 19, a permanent magnet 18, and a back yoke 17. Other components, which are the same as those in FIG. 1, are denoted by same reference signs as those in FIG. 1, and description thereof is omitted. In FIG. 6, at the time of start-up of the rotating electric machine, the tension of the V-shaped belt 15 increases. Hence, the variable position rotating pulley 8 is moved rightward, and the air gap between the permanent magnet 18 and the stator 19 is smallest. In this state, a high start-up torque is generated, and a V-groove interval between the pulleys of the primary-side shaft of the CVT is wider. Hence, the diameter of the V-shaped belt 15 is small, and the rotating electric machine can be easily started up at a speed reducing ratio.

A flange portion of a secondary-side flanged rotating shaft 20 of the CVT has a tapered shape. A pulley 21 rotates around a shaft center of the rotating shaft 20, and is fixed so as to be immovable in the thrust direction. The V-shaped belt 15 is pressurized by a spring 23, and the tapered flange portion of the rotating shaft 20 and the pulley 21 hold the V-shaped belt 15 therebetween. The spring 23 is held by a spring stopper 22 attached to the rotating shaft 20. Because a distance between the primary-side shaft and the secondary-side shaft of the CVT is fixed, if the V-groove interval between the pulleys becomes wider on the primary side, the V-shaped belt 15 becomes looser on the secondary side. Consequently, the tapered flange portion of the rotating shaft 20 enters an inner peripheral portion of the V-shaped belt 15 due to the pressurization of the spring 23. In this way, the state in FIG. 6 suitable for start-up and acceleration is obtained.

FIG. 7 illustrates a state suitable for a light load at a constant speed or high-speed rotation. At the time of a constant-speed operation or a high-speed operation after an end of the acceleration, the load significantly decreases compared with that at the time of the acceleration, and hence the tension of the V-shaped belt 15 also decreases. On the basis of a relation of speed-torque characteristics of the BLDCM, as the speed increases, the load current decreases, and hence the attraction force applied to the gap also decreases. Consequently, the variable position rotating pulley 8 enters an inner portion of the V-shaped belt 15 due to pressurization of a spring 16 and the like. At a same time, the tension of the V-shaped belt 15 is transmitted to the secondary side. Because the pulley 21 is fixed so as to be immovable in the thrust direction, the tapered flange portion of the rotating shaft 20 is moved leftward by the tension of the V-shaped belt 15, and the V-groove interval becomes wider. In this way, the state in FIG. 7 suitable for the high-speed rotation is obtained.

If a windmill or the like is attached to the secondary-side shaft of the CVT in FIG. 6 and FIG. 7, the rotating electric machine provided to the primary-side shaft of the CVT can be used as a power generator. FIG. 6 corresponds to an operation at the time of a gentle wind, in which the secondary-side shaft rotates at a low speed. Hence, a speed of the power generator of the primary-side shaft is increased, and the number of rotations is increased, whereby an amount of generated power can be made larger. FIG. 7 corresponds to an operation at the time of a strong wind, in which the secondary-side shaft rotates at a high speed. Hence, the rotation speed of the primary-side shaft is reduced, whereby the amount of generated power can be made smaller and damage due to the high-speed rotation of the power generator can be prevented.

### Second Embodiment

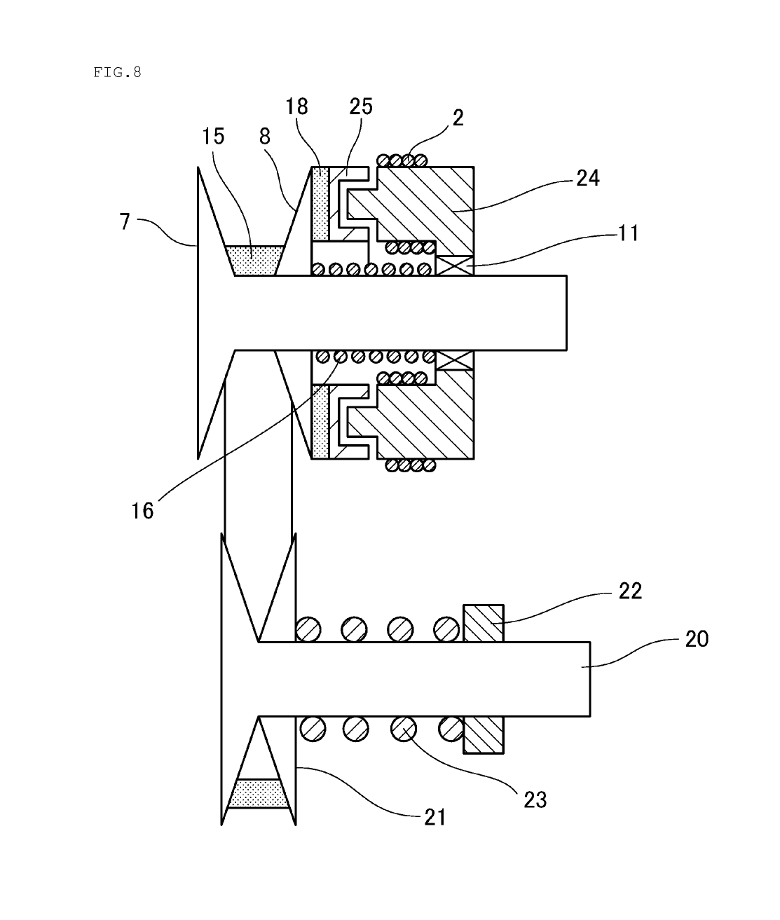

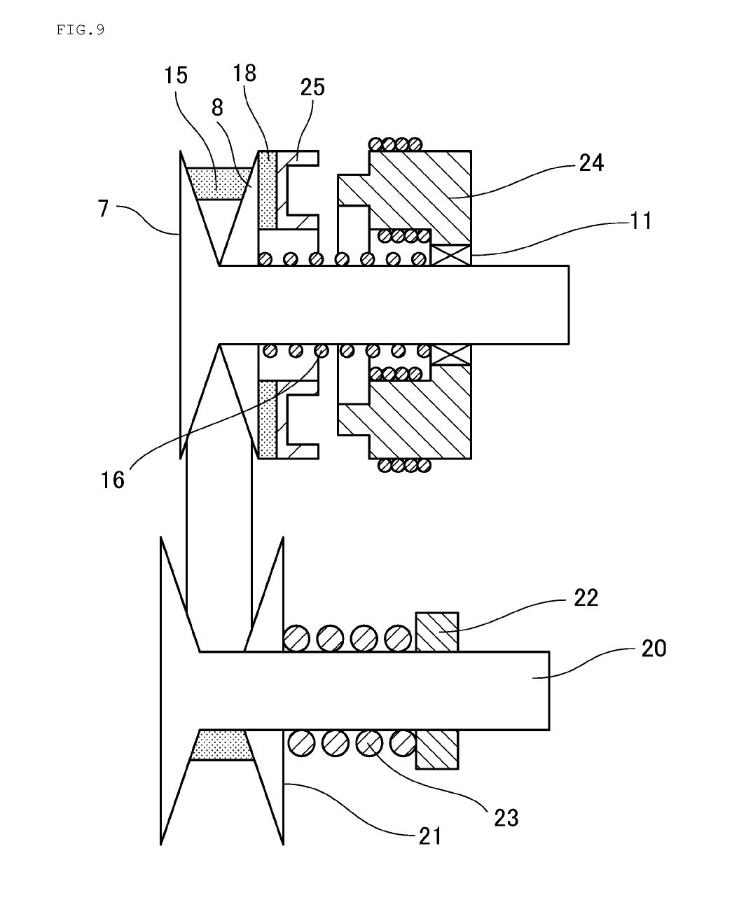

FIG. 8 and FIG. 9 are explanatory views each illustrating a rotating electric machine according to a second embodiment, together with a primary side and a secondary side of a CVT. Similarly to FIG. 1 and FIG. 4, an air gap for mutual engagement between a stator iron core part 24 and rotor magnetic poles 25 in a motor unit is formed in a concavo-convex shape, and the number of concavo-convex tooth parts for mutual engagement is smaller than an actual number thereof for simplification of the drawings. Further, similarly to FIG. 1 and FIG. 4, FIG. 8 and FIG. 9 have an advantage that an axial gap rotor and a variable position rotating pulley of the CVT are combined with each other and thus can move in a thrust direction at a same time. The permanent magnet 18 is attached to the rotor magnetic poles 25. The variable position rotating pulley 8 is made of a magnetic material, and substitutes for a back yoke. Other components, which are the same as those in FIG. 1, are denoted by same reference signs as those in FIG. 1, and description thereof is omitted.

An operation of FIG. 8 and FIG. 9 is the same as that of FIG. 6 and FIG. 7, and hence description thereof is omitted. In FIG. 8, the air gap in the rotating electric machine is smallest, a V-groove of the CVT is largest, a diameter of a V-shaped belt on the primary side of the CVT is smallest, and the diameter of the V-shaped belt on the secondary side of the CVT is largest accordingly. That is, FIG. 8 corresponds to an operation at the time of start-up or acceleration. Conversely, in FIG. 9, the air gap in the rotating electric machine is largest, the V-groove of the CVT is smallest, the diameter of the V-shaped belt on the primary side of the CVT is largest, and the diameter of the V-shaped belt on the secondary side of the CVT is smallest accordingly. That is, FIG. 9 corresponds to an operation at the time of high-speed rotation.

If a windmill or the like is attached to a secondary-side shaft of the CVT in FIG. 8 and FIG. 9, the rotating electric machine provided to a primary-side shaft of the CVT can be used as a power generator. FIG. 8 corresponds to an operation at the time of a gentle wind, in which the secondary-side shaft rotates at a low speed. Hence, a speed of the power generator of the primary-side shaft is increased, and the number of rotations is increased, whereby an amount of generated power can be made larger. FIG. 9 corresponds to an operation at the time of a strong wind, in which the secondary-side shaft rotates at a high speed. Hence, the rotation speed of the primary-side shaft is reduced, whereby the amount of generated power can be made smaller and damage due to the high-speed rotation of the power generator can be prevented. In a case of adopting the rotating electric machine illustrated in FIG. 4B, the secondary-side shaft is not provided, and a windmill or the like is attached directly to the rotating member 28 to be used as a power generator.

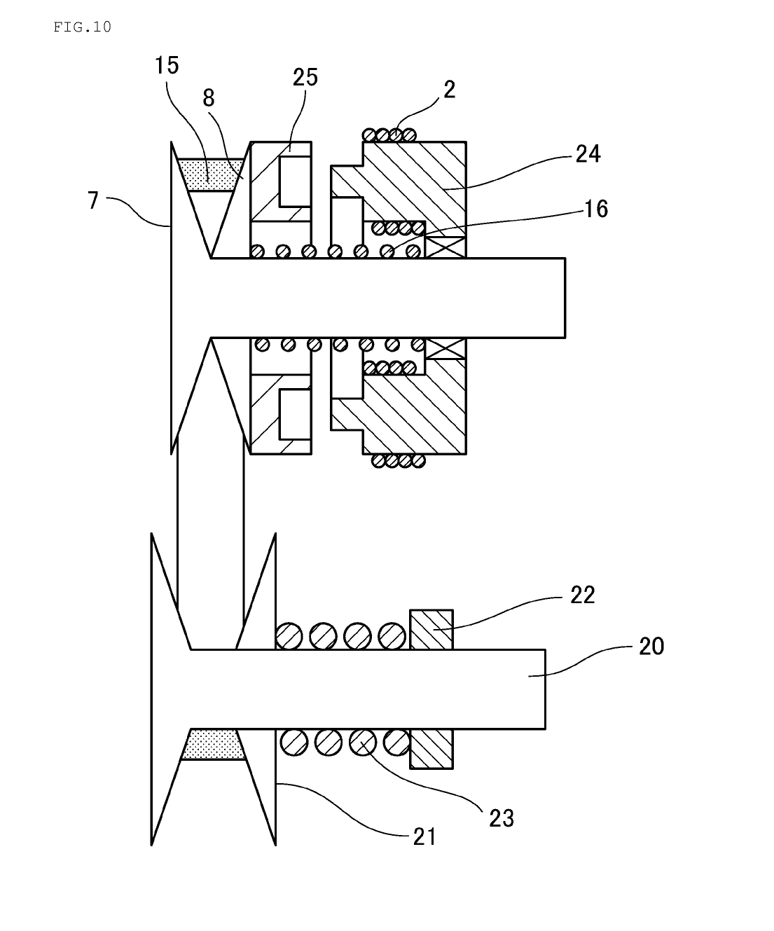

FIG. 10 illustrates an example in which: the stator iron core part 24 and the rotor magnetic poles 25 of the motor respectively include first tooth parts and second tooth parts, between which a concavo-convex air gap is formed, similarly to FIG. 8 and FIG. 9; and the permanent magnet 18 is not used unlike the BLDCM in FIG. 8 and FIG. 9. This example is a so-called reluctance rotating electric machine, which is a rotating electric machine that attracts attention as a SRM in recent years. The stator and the rotor in an air gap opposing portion observed from the axial direction are the same as those in FIG. 2 and FIG. 3. Because this machine is rotated by an attraction force, as the air gap is smaller and as an air gap opposing area is larger, a generated torque is higher. Further, because the permanent magnet is not used, this machine is less expensive, but the generated torque is lower, compared with the BLDCM. Hence, the concavo-convex air gap needs to be formed in a case of use for an EV and the like. Although not as obvious as in the BLDCM, as the air gap is larger, the rotation speed is higher. Accordingly, it is advantageous to apply a device of the CVT of the present invention to the axial gap type SRM. FIG. 10 corresponds to an operation at the time of high-speed rotation, in which the air gap is increased.

The torque of the rotating electric machine is proportional to an interlinkage magnetic flux. The interlinkage magnetic flux is proportional to a gap permeance P, and the gap permeance P is obtained by the following expression.

P=μ₀S/L (1)

where μ₀ represents magnetic permeability in vacuum, S represents a gap opposing area, and L represents an air gap length.

In considering Expression (1), the present invention motor includes a concavo-convex gap as an air gap, as shown in FIGS. 1, 8 and the like, and hence the opposing area S thereof can be easily twice to three times that of the conventional motor. Accordingly, the permeance P of the present invention motor is also twice to three times, and the torque thereof can be increased in proportion to P. Accordingly, a decrease in torque caused by an increase in air gap, which is a disadvantage of the axial gap type motor compared with the radial gap type motor, can be improved. As described above, if the concavo-convex air gap is tried to be adopted, assembling of the stator and the rotor is not easy in the radial gap type motor, whereas assembling thereof is easy in the axial gap type motor. Although the present invention uses the pressed powder core, lower magnetic permeability of the pressed powder than that of the silicon steel plates can be covered by effects produced by the concavo-convex gap. Here, characteristics of the concavo-convex gap type axial motor are described in comparison with a so-called plane gap type axial motor in which a stator and a rotor are planarly opposed to each other.

With reference to FIGS. 11 and 12, characteristics of a torque T when the air gap length L is changed are compared. FIGS. 11A and 11B illustrate the plane gap type axial motor, in which the permanent magnet 18 of the rotor is directly opposed to the stator 19 while the air gap is held therebetween. In FIG. 11A, the air gap is as small as L1. In FIG. 11B, the air gap is increased to L2. In comparison, FIGS. 11C and 11D illustrate the concavo-convex gap type axial motor. In FIG. 11C, the air gap is as small as L1. In FIG. 11D, the air gap is increased to L2. With reference to FIG. 12, even if the air gap is the same L1, the torque of the concavo-convex gap type is approximately twice that of the plane gap type. As the air gap length L increases, the torque of the plane gap type decreases in inverse proportion to a square of the air gap length L, whereas the torque of the concavo-convex gap type decreases substantially linearly as shown in FIG. 12 until the air gap length L reaches L2. This is because, in the concavo-convex gap type, the first tooth parts of the stator and the second tooth parts of the rotor are always opposed to each other in the radial direction. In a case of such a linear decrease in torque, the torque can be linearly controlled by variable control of the air gap length L, and control of a car from a low speed to a high speed is facilitated if the motor is used as a motor for EV. Further, according to results obtained by experimental production, although the present invention motor is the axial gap type motor, the present invention motor includes a radial gap type opposing portion, and hence noise is significantly lower than that in a plane gap type axial motor.

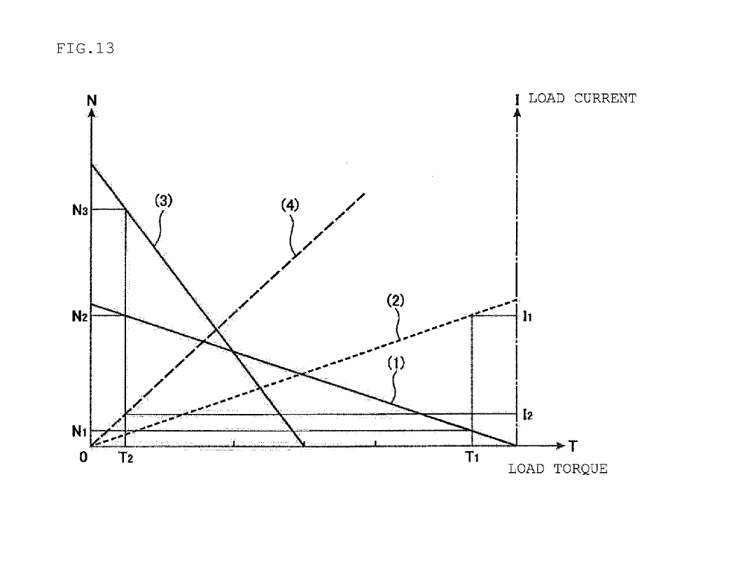

FIG. 13 is a graph for describing characteristics when the air gap of the axial variable air gap type motor of the BLDCM is varied. A speed-load torque characteristic at the time of a minimum air gap is indicated by a solid line (1), and a current-load torque characteristic at this time is indicated by a dotted line (2). With reference to a speed-load torque curve indicated by the solid line (1) at the time of the minimum air gap, if the motor is started up with a start-up torque T1 and a speed N1, a current I1 is close to a maximum current, and the attraction force in the axial direction is large. If the attraction force in the axial direction is set to be larger than a precompressed spring force, the motor is started up with a high torque while holding the minimum air gap, and then increases its speed. Along with the increase in speed, the load torque decreases, and the load current also decreases. Consequently, the attraction force in the axial direction also decreases to become smaller than the precompressed spring force, and the air gap increases. A speed-load torque characteristic at the time of a maximum air gap when the gap length has increased up to a predetermined air gap is indicated by a solid line (3), and a current-load torque characteristic at this time is indicated by a dotted line (4). At this time, the load torque is T2, and the current is I2. That is, the speed-load torque characteristic of the present invention motor continuously smoothly changes from the solid line (1) to the solid line (3), and the load is started up and accelerated. If the speed-load torque characteristic is only the solid line (1) with the air gap being fixed, when the load torque is T2, the speed increases up to only N2. In contrast, according to the variable air gap type motor of the present invention, the speed can increase up to N3 on the speed-load torque characteristic (3). In order to change the speed-load torque characteristic to (1) by field strengthening control and change the same to (3) by field weakening control, an extra exciting coil, field control power, a complicated vector control circuit, or the like is necessary.

Although description is given above mainly of the axial gap type BLDCM in which the respective opposing surfaces of the stator and the rotor are formed in concavo-convex shapes for mutual engagement, the respective opposing surfaces thereof may be formed in arc-like or triangular tooth shapes for mutual engagement, and sufficient effects can be produced even in this case. Similarly for a SRM, in which a permanent magnet is not used, the respective opposing surfaces of the stator and the rotor may be formed in concavo-convex, arc-like, or triangular tooth shapes for mutual engagement, and sufficient effects can be produced even in this case. In a case of the SRM, the speed-torque curve shown in FIG. 13 is not as straight as that of the BLDCM, but the characteristic curve changes with a tendency of approximately from (1) to (3) along with an increase in air gap. Accordingly, application of the present invention to the SRM is also advantageous because an inexpensive motor that does not require a permanent magnet can be adopted.

The axial gap type rotating electric machine according to the present invention is inexpensive and robust, achieves reduction in weight, thickness, length, and size, achieves improvement in torque and efficiency, generates lower noise, and is simple and extremely practical. Accordingly, industrially great contributions of the axial gap type rotating electric machine are expected.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2013-220285 filed on Oct. 23, 2013 including the specification, claims, drawings and summary is incorporated herein by reference in its entirety.

What is claimed is:

1. A rotating electric machine comprising:
a stator;
a rotor that is rotatably arranged with an intermediation of an air gap in a rotating shaft direction with respect to the stator; and
a primary-side mechanism that rotates concentrically with a shaft center of the rotor, wherein
the primary-side mechanism includes: a fixed position rotating pulley that is arranged so as to be immovable in the rotating shaft direction; and a variable position rotating pulley that is arranged so as to be movable in the rotating shaft direction with respect to the fixed position rotating pulley, and
the variable position rotating pulley rotates and moves in an axial direction integrally with the rotor.

2. The rotating electric machine according to claim 1, wherein
the variable position rotating pulley includes a conical internal space part between the variable position rotating pulley and the rotor,
a plate having a surface oppositely inclined to an inner wall surface of the conical internal space part is provided in the space part so as to be immovable in the axial direction,
a weight made of one piece or a plurality of divided pieces is arranged in a circumferential direction of the rotating shaft in a space defined by the inner wall surface of the conical internal space part and the plate, and
the pieces of the weight are continuously connected using an elastic member that urges the weight in a diameter reducing direction as needed.

3. The rotating electric machine according to claim 1, wherein
the rotor comprises a permanent magnet that has an even number of poles and is magnetized into opposite polarities in the circumferential direction.

4. The rotating electric machine according to claim 1, wherein
the rotor does not comprise a permanent magnet.

5. The rotating electric machine according to claim 1, wherein
the stator includes a stator iron core part including a plurality of salient-pole iron cores for a winding wire,
the salient-pole iron cores for the winding wire include first tooth parts that protrude in the axial direction and are formed in a concentric arc-like manner,
the salient-pole iron cores for the winding wire each have a winding wire shaft formed parallel to the rotating shaft and are arranged in a distributed manner in the circumferential direction,
the rotor includes rotor magnetic poles that are made of a plurality of magnetic materials and are arranged in a distributed manner in the circumferential direction, and
the rotor magnetic poles include second tooth parts that protrude in the axial direction and are formed in a concentric arc-like manner, the second tooth parts being opposedly arranged so as to respectively engage with the first tooth parts with the intermediation of the air gap.

6. The rotating electric machine according to claim 1, wherein
a continuously variable transmission is configured by: forming a variable width V-groove using the fixed position rotating pulley and the variable position rotating pulley of the primary-side mechanism and a fixed position rotating pulley and a variable position rotating pulley of a secondary-side mechanism; and stretching a V-shaped belt around the variable width V-groove.

7. The rotating electric machine according to claim 6, wherein
electric power is inputted to any one of the stator and the rotor, the one including a winding wire,
the primary-side mechanism is rotated, and
an output is obtained from the secondary-side mechanism.

8. The rotating electric machine according to claim 6, wherein
a driving force generated by an external force such as wind power, water power, or an engine is inputted to the secondary-side mechanism, and
a rotating electric machine provided to the primary-side mechanism is used as a power generator.
